(19) United States
(12) Patent Application Publication
(10) Pub. No.: US 2010/0035057 A1
(43) Pub. Date: Feb. 11, 2010

(54) PRIMER COMPOSITION AND ADHESIVE SUBSTRATE

(76) Inventor: Neyoshi Ishida, Kanagawa (JP)

Correspondence Address: 3M INNOVATIVE PROPERTIES COMPANY, PO BOX 33427, ST. PAUL, MN, 55133-3427, US

(21) Appl. No.: 12/523,338

(22) PCT Filed: Jan. 4, 2008
(86) PCT No.: PCT/US08/50255

§ 371 Date: Jul. 16, 2009

(30) Foreign Application Priority Data
Jan. 30, 2007 (JP) 2007-019336

(51) Int. Cl. B32B 27/32; C09D 133/00

(52) U.S. Cl. 428/353; 524/186

(57) ABSTRACT

To provide a primer for imparting high adhesive property and high heat resistance to the surface of a substrate. The primer composition is constructed to comprise (1) a maleic acid-modified polyolefin, (2) an organic diamine having a number average molecular weight of at least 150, and (3) a solvent.

### TECHNICAL FIELD

The present invention relates to a primer composition. More specifically, the present invention relates to a primer composition capable of imparting good adhesive property and heat resistance to particularly a polyolefin-based substrate, and a synthetic resin substrate surface-treated with such a primer composition.

### BACKGROUND

Conventionally, it is known that a so-called polyolefin-based material such as polypropylene is extremely poor in the adhesive property among a large number of synthetic resin materials and bonding of other members to a part, a member, a product or the like (hereinafter collectively referred to as a “substrate”) comprising a polyolefin-based material is difficult. Various methods have long been employed to overcome this difficulty, and a general method is to coat an appropriate primer on the substrate and thereby modify the chemical property of the surface.

As for the primer for polyolefin, a chlorinated polypropylene is well known because of its good adhesive property and has long been employed. For example, Japanese Unexamined Patent Publication (Kokai) No. 5-311100 describes a technique of using a chlorinated polypropylene as a primer so as to improve the adhesion of a coating material to a polypropylene molded article.

However, use of a chlorine-based material is recently avoided in view of environmental consideration, and this is not an exception also in the field of primer. In place of the chlorinated polypropylene, a polyolefin modified with a maleic acid comes to be used (see, for example, Japanese Examined Patent Publication (Kokoku) Nos. 6-80844 and 7-47705).

It is proposed also in other patent documents to use a polyolefin modified with a maleic acid or other compounds. For example, in International Publication WO 99/00460, a bonding composition containing a polyolefin or polyamine modified with a maleic acid is used to bond a polyolefin-based material to a member comprising a fluoropolymer. In U.S. Pat. No. 6,462,130, a polyamide-modified polyolefin composition is used so as to achieve excellent adhesive force of a coating material, an adhesive or the like for a polyolefin-based substrate. In European Patent No. 1423441, a primer composition containing at least one kind of a carboxylated polyolefin modified with one or more kinds of polyfunctional alcohols is used so as to improve the adhesive force of a coating material, an adhesive, an ink or the like for a plastic or metal substrate.

### SUMMARY

As described above, a polyolefin modified with a maleic acid or other compounds is well known, but when viewed as a primer, there is still room for improvement in the enhancement of adhesive property. For example, the traditional chlorinated polypropylene can exhibit high adhesive property of approximately from 10 to 50 N/25 mm (according to the 180° peel adhesive strength prescribed in JIS K6854 (1999)), whereas the adhesive strength of the maleic acid-modified polyolefin or the like heretofore proposed is about 10 N/25 mm at the highest.

Accordingly, an object of the present invention is to provide a primer ensuring an adhesive property greatly higher than that of a maleic acid-modified polyolefin or the like and having excellent heat resistance as well as characteristic features which should be originally possessed by a primer, such as stabilization of substrate surface, maintaining of adhesive property, good coatability and good thin film formability.

Another object of the present invention is to provide a substrate, particularly, a synthetic resin-made substrate, assured of excellent surface adhesive property, heat resistance of the coated primer, surface stability and the like.

As a result of intensive studies to achieve the above-described objects and other objects, the present inventors have found that when a maleic acid-modified polyolefin as a base compound is used as it is and a specific organic diamine is used in combination, an improved primer composition having characteristic features suitable as a primer, including high adhesive property and heat resistance, can be provided.

In one aspect, the present invention is a primer composition comprising the following components:

(1) a maleic acid-modified polyolefin,

(2) an organic diamine having a number average molecular weight of at least 150, and

(3) a solvent.

In the maleic acid-modified polyolefin, the maleic acid used for modifying the polyolefin includes a maleic acid, a maleic anhydride and a mixture thereof.

In another aspect, the present invention is an adhesive substrate having on the surface thereof a primer-treated layer comprising the primer composition of the present invention.

According to the present invention, as is understood from the following detailed description, a primer composition exhibiting, when used as a primer, a high adhesive property equal to or greater than that of the traditional chlorinated polypropylene, for example, approximately from 10 to 50 N/25 mm, can be provided. Also, this primer composition has excellent heat resistance and therefore, can stably maintain the high adhesive property. In addition, similarly to the conventional primers, this primer composition can be used in a simple and easy manner by a spraying method, a coating method, a dipping method or the like and at the same time, can successfully exhibit various properties which should be originally possessed by a primer, such as stabilization of substrate surface, coatability and thin film formability.

Furthermore, although the primer treatment can effectively function for various substrates, its operational effect can be remarkably exerted when applied to a synthetic resin-made substrate, particularly, a substrate comprising a polyolefin-based material.

### BRIEF DESCRIPTION OF THE DRAWINGS

FIG. 1 is a schematic view showing one application example of the primer composition of the present invention.

FIG. 2 is a schematic view showing the behaviors of the maleic acid-modified polyolefin and organic diamine in the primer coat of FIG. 1.

FIG. 3 is a schematic view showing the procedure of the heat resistance test used in Examples.

### DETAILED DESCRIPTION OF THE PREFERRED EMBODIMENTS

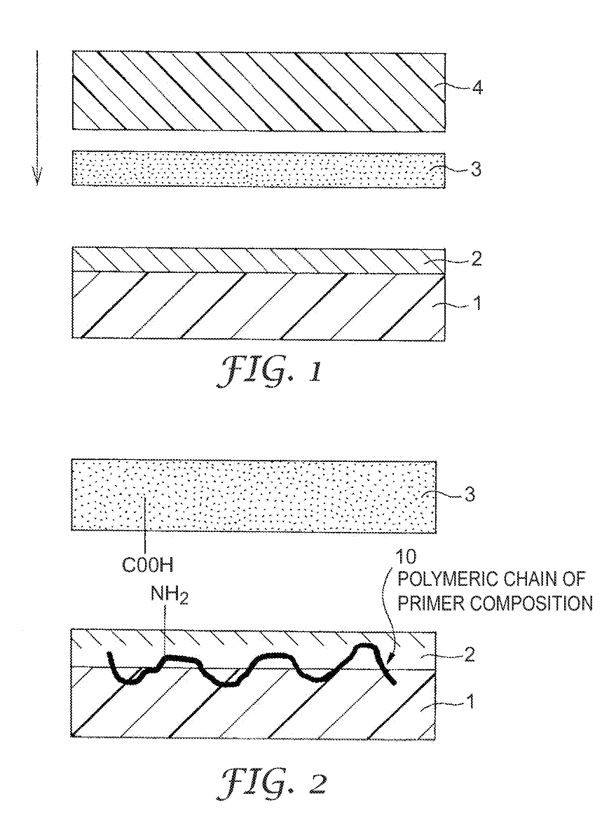

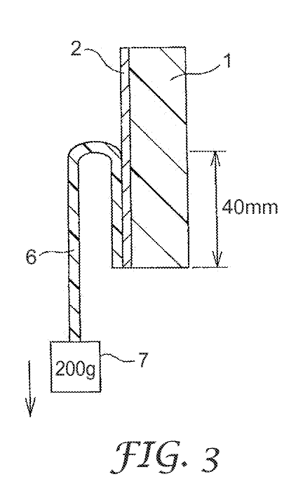

The present invention can be advantageously implemented in various embodiments. The preferred embodiments of the present invention are described below by referring to FIGS. 1 and 2, but the present invention is not limited to the following embodiments.

First, the present invention is a primer composition comprising at least the following components:

(1) a maleic acid-modified polyolefin,

(2) an organic diamine having a number average molecular weight of at least 150, and

(3) a solvent.

The primer composition of the present invention is coated on a substrate by using a method such as spraying for the purpose of applying it to the substrate surface and thereby enhancing the adhesive property of the surface. For example, a primer coat can be formed at a thickness of approximately from 0.1 to 50 μm by applying a solution or the like of the primer composition according to an arbitrary method such as spraying, coating or dipping. In view of the character as a primer, the primer coat is preferably formed thinly. Usually, the primer coat is more preferably formed to a thickness of approximately from 1 to 10 μm.

FIG. 1 is a view showing one application example of the primer composition of the present invention. In the figure, a primer coat 2 formed by coating and curing the primer composition of the present invention is present on the top surface of a substrate 1. At the time of bonding an adherend 4 to the substrate 1, the adherend 4 is moved down as shown by the arrow in the figure, but good bonding therebetween can be achieved by pressing the adherend 4 against the substrate 1 through an adhesive layer 3. The primer coat 2 is excellent also in the heat resistance and therefore, the adherend 4 after bonding does not come off from the substrate 1, for example, under high-temperature application.

In the practice of the present invention, the substrate having a surface which should be subjected to a primer treatment is a metal, a synthetic resin or the like and is not particularly limited. However, since the object of the present invention is to overcome the problem that the conventional primer coat formed on a substrate is poor in the adhesive property, the substrate used here is preferably a synthetic resin material, particularly, a polyolefin-based material. The polyolefin-based material is a polyolefin-based polymer or copolymer and examples thereof include a polyethylene, a polypropylene, a polybutylene, an ethylene propylene copolymer and an ethylene proprene diene. The shape of the substrate is not limited. For example, the substrate may be a plate as shown in the Figure or may be a sheet or a molded article imparted with an arbitrary desired shape. Examples of the molded article include an automobile component, a home appliance component, a floor material and a heat insulator.

The surface of the substrate may be used as it is or may be subjected to a surface roughening treatment or a cleaning treatment so as to improve the compatibility with the primer composition. In order to remove contamination of the support, a wiping treatment, for example, with an alcohol is preferably applied. Alternatively, the substrate surface may be reformed by a plasma treatment, a corona discharge treatment or the like.

The maleic acid-modified polyolefin which is a first component of the primer composition of the present invention is not particularly limited. The maleic acid-modified polyolefin is obtained by graft-copolymerizing a maleic acid or an anhydride thereof to a polyolefin-based polymer or copolymer. The polyolefin-based polymer or copolymer is not particularly limited.

More specifically, examples of the polyolefin-based polymer or copolymer include, but are not limited to, a polyethylene, a polypropylene, a polybutylene, an ethylene propylene copolymer and an ethylene proprene diene. The polyolefin-based copolymer, for example, when taking a random copolymer construction, is useful particularly for formation and function of the primer. The number average molecular weight of the polyolefin-based polymer or copolymer is usually on the order of 10,000 to 200,000 but is not limited thereto.

The maleic acid-modified polyolefin can be prepared according to a normal method by using the above-described polyolefin-based polymer or copolymer as a starting material. For example, the maleic acid-modified polyolefin may be prepared by a method of dissolving the starting material in an organic solvent, adding a maleic acid or an anhydride thereof and a radical generator, and heating the solution under stirring. The radical generator added to participate in the graft reaction is not particularly limited as long as it can contribute to the reaction. For example, an organic peroxide or an organic perester, such as di-tert-butyl peroxide, tert-butyl peroxyisobutyrate and tert-butyl peroxyoctate, may be used as the radical generator. The reaction temperature is suitably from 60 to 150° C., and the stirring time is suitably on the order of 1 to 10 hours. The reaction operation may be either a continuous system or a batch system, but a batch system is preferred for performing a uniform graft reaction.

Alternatively, the maleic acid-modified polyolefin may be prepared by allowing the graft reaction solution to stand as it is or diluting the solution with a solvent. Also, the maleic acid-modified polyolefin may be prepared by isolating the modified polyolefin prepared and further dissolving it in a solvent. Furthermore, a melting method may also be employed in place of the solution method. For example, the maleic acid-modified polyolefin may be prepared by supplying the starting materials all together or stepwise to an extrusion molding machine, performing graft polymerization or copolymerization, and dissolving the obtained product in a solvent.

In the practice of the present invention, it is important to use an organic diamine in combination with the maleic acid-modified polyolefin. The present inventors have made studies on various kinds of organic amines and found that only an organic diamine, particularly an organic diamine having a number average molecular weight of at least 150, is effective for the implementation of the present invention. The present invention has been accomplished based on this finding.

The operation and effect of the organic diamine having a low molecular weight added in combination with the maleic acid-modified polyolefin are not yet accurately clarified, but the present inventors consider that when the number average molecular weight is less than 150, the following reaction proceeds on the substrate surface and gelation occurs.

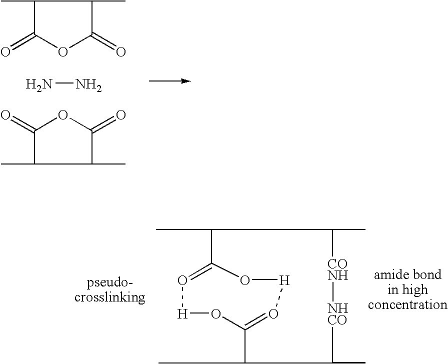

That is, by the addition of a diamine having a molecular weight of less than 150 to the maleic acid-modified polyolefin, a ring-opening reaction shown above takes place in a part of the primer composition and “amide bond in high concentration” and “pseudo-crosslinking” are created, but in the present invention, such undesired behaviors can be avoided and great enhancement is thereby achieved in the adhesive property and heat resistance. Such a ring-opening reaction is considered to occur because when the molecular weight of diamine is too low, the maleic acid-modified polyolefins which react are caused to locate at the positions very close to each other, as a result, a pseudo-crosslinking is generated between carboxylic acid groups to reduce the solubility of the polyolefin and furthermore, since an amide bond having high polarity is locally produced in a high concentration, the solubility of polyolefin is also reduced. On the contrary, when the number average molecular weight is high and 150 or more as in the present invention, carboxylic acid groups are kept apart by an appropriate distance and localization of an amide bond does not arise, whereby the dissolution of the polyolefin is facilitated.

As described above, the organic diamine for use in the present invention needs to have a number average molecular weight (Mn) of at least 150. The upper limit of the molecular weight (Mn) of the organic diamine is not particularly limited but is usually about 4,000. The molecular weight (Mn) of the organic diamine is preferably on the order of 150 to 1,000, more preferably on the order of 200 to 800.

In the practice of the present invention, as long as such a number average molecular weight requirement is satisfied, organic diamines of different types may be arbitrarily used individually or in combination. Suitable examples of the organic diamine include, but are not limited to, an aliphatic diamine, an aromatic diamine, a polyether diamine, a polyamide amine, a modified polyamine and a silicone diamine.

More specifically, the aromatic diamine includes the following compounds.
Aliphatic diamine: isophorone diamine (Mn: 170), norbornene diamine (Mn: 160)
Aromatic diamine: xylylene diamine (Mn: 136), tolylene diamine (Mn: 150)
Polyether diamine: Jeffamine D230 (produced by San Techno Chemical, Mn: 230), Jeffamine D400 (produced by San Techno Chemical, Mn: 400)
Polyamide amine: Sanmide 300 (produced by Sanwa Chemical, estimated Mn: 1,000), Sanmide 305 (produced by Sanwa Chemical, estimated Mn: 300)
Modified polyamine: 130X (produced by Sanwa Chemical, estimated Mn: 300)
Silicone diamine: KF-8012 (produced by Shin-Etsu Chemical, Mn: 4,000)

In the practice of the present invention, such an organic diamine can be used in various amounts. Usually, the organic diamine is used advantageously in an amount of approximately from 5 to 50 wt % based on the weight of the maleic acid-modified polyolefin in the primer composition. If the amount of the organic diamine exceeds 50 wt %, the finally obtained primer coat (thin film) becomes too soft and causes not only a tacky state but also easy separation from the substrate. The amount of the organic diamine is more preferably on the order of 5 to 30 wt %.

The primer composition is completed in the state that the maleic acid-modified polyolefin and the organic diamine are dissolved or dispersed in a solvent. For example, these primer components may be dissolved in an organic solvent to prepare a coating solution or may be dispersed in water to prepare an aqueous coating emulsion. The organic solvent is not particularly limited, but from the standpoint of preventing the environmental pollution, a mild solvent, for example, methyl cyclohexane, ethyl acetate or a mixture of these solvents, may be advantageously used.

It is advantageous that the primer composition can be easily handled and is used at a viscosity suitable for the coating on a substrate. The viscosity of the primer composition is usually on the order of 5 to 500 cps, preferably on the order of 10 to 100 cps. The viscosity can be easily adjusted by varying the amount of the solvent added.

After preparing the primer composition in this way, a primer coat is formed as briefly referred to above. The primer coat can be formed by coating a solution or the like of the primer composition on a substrate according to an arbitrary application method such as spraying, coating or dipping, and then drying it. The drying conditions are approximately from 25 to 70° C. and approximately from 1 to 20 minutes. In view of the character as a primer, the primer coat is preferably formed thinly. Usually, the thickness (after drying) of the primer coat is preferably on the order of 1 to 50 μm, more preferably on the order of 1 to 10 μm.

FIG. 2 shows the behaviors of the maleic acid-modified polyolefin and organic diamine in the primer coat when an adhesive layer is bonded to a substrate having formed thereon the primer coat. When the primer composition of the present invention is coated on a polyolefin-based substrate 1 to form a primer coat 2 and an adhesive layer 3 is bonded to the primer coat 2, the maleic acid-modified polyolefin of the primer composition penetrates inside the polyolefin-based substrate 1 similarly to the conventional chlorinated polypropylene. Note in FIG. 2 that the curve 10 means a polymeric chain of the primer composition and the penetration state is schematically shown for easy understanding and in practice, various penetration modes are present.

While penetration of the maleic acid-modified polyolefin is occurring in this way, an organic amine-derived amino group (—NH₂) extending from the formed primer coat 2 exhibits high affinity for a polar group including a carboxyl group (—COOH) contained in the adhesive layer (for example, acryl-based pressure-sensitive adhesive) 3. By virtue of these behaviors, actions of

(1) good intertwining with the substrate molecule, resulting from penetration of the malic acid-modified polyolefin into the substrate surface,

(2) good mutual attraction between the primer coat and the adhesive, which is attributable to the state that an organic diamine having high affinity for a polar group of the adhesive is present in the primer coat,

are simultaneously and synergistically brought about, whereby the primer coat of the present invention can provide an innovatively effective operational effect unrecognized in conventional primers.

In addition to these primer composition and primer coat, the present invention provides a substrate subjected to a primer treatment or equipped with a primer coat, which is produced by using the primer composition or primer coat, and an article containing such a substrate.

Usually, the substrate is preferably a synthetic resin-made substrate, more preferably a polyolefin-based substrate. The details of the substrate and the details of the primer composition or primer coat applied to the substrate surface are already described, and repeated description thereof is omitted here.

According to the present invention, an arbitrary adherend is bonded and fixed to the surface of a substrate subjected to a primer treatment or equipped with a primer coat, through an adhesive layer. This series of operations can be performed by using techniques conventionally employed in general.

The adhesive layer used here is not particularly limited. For example, the adhesive layer is formed by using an acryl-based adhesive. As described above, since the polar group contained in the adhesive greatly governs the effect of the present invention, an adhesive allowing for the presence of many effectively acting polar groups is useful. A particularly useful adhesive is an acryl-based adhesive. The thickness of the adhesive layer is usually on the order of 1 to 10 μm. Also, the adhesive layer is preferably stored usually in the form of a lengthy article (for example, a roll) lined with a release liner, and used on demand by cutting it to a desired length.

The adherend bonded to the substrate through the adhesive layer is also not particularly limited and may be arbitrarily selected by taking into account the adhesive property of the adhesive layer. Suitable examples of the adherend include various fixings and components to be fit on a substrate used in vehicles such as automobile and electric train, ships and home electric appliances. In addition to such a shaped article, if desired, the adherend may be a sheet-like article such as emblem, seal and decorative film or may be a coating such as paint film.

### Examples

The present invention is described below by referring to the examples thereof. Note that the present invention is not limited to these examples.

### Preparation Example 1

### Preparation of Maleic Acid-Modified Polyolefin:

In a four-neck flask equipped with a stirrer, a condenser tube, a thermometer and a dropping funnel, 300 g of a polypropylene-butene-ethylene copolymer (number average molecular weight: 68,000) was dissolved in 700 g of toluene under heating. While keeping the obtained solution at a temperature of 115° C., 13 g of maleic anhydride and 12 g of di-tert-butyl peroxide each was added dropwise over 2 hours with stirring. After the completion of dropwise addition, ripening was performed for 3 hours, thereby allowing the graft reaction to proceed. Subsequently, the reaction product was cooled to room temperature and then charged into 20 liter (L) of acetone. The objective maleic acid-modified polyolefin (hereinafter referred to as “MMPO”) was obtained at a yield of about 90%.

### Example 1

A 1:1 mixture of methylcyclohexane and ethyl acetate was added to the maleic acid-modified polyolefin (MMPO) prepared in Preparation Example 1 to prepare an MMPO solution having a solid content of 5%. Subsequently, 5 wt % (based on the entire amount of the maleic acid-modified polyolefin) of polyether diamine (number average molecular weight: about 800) was added to the MMPO solution as shown in Table 1 below, and the resulting solution was stirred at room temperature for 1 hour. A primer solution containing MMPO and organic diamine was obtained.

### Examples 2 to 6

The procedure of Example 1 was repeated but as shown in Table 1 below, the amount of polyether diamine added was changed in Examples 2 to 4 and a commercial product, Jeffamine D230 or D400, was used as the organic diamine in Examples 5 and 6. Similarly to Example 1, primer solutions each containing MMPO and organic diamine were obtained.

### Comparative Examples 1 to 8

The procedure of Example 1 was repeated but for the purpose of comparison, as shown in Table 1 below, the addition of polyether diamine was omitted and an organic monoamine (“2E4MZ Imidazole”, trade name, produced by Atlas Chemical Industries, Inc.) was used in Comparative Examples 1 and 2, and xylylene diamine or hexamethylene diamine having a number average molecular weight of 136 or 116, respectively, was used in Comparative Examples 4 to 8. As shown in Table 1 below, only unsatisfactory results could be obtained.

### Adhesive Property Test

Using the primer solutions prepared in Examples 1 to 6 and Comparative Examples 1 to 8, an adhesive property test (180° peel adhesive strength test) was performed according to the following procedure and the adhesive property was evaluated from the value of peel strength (N/25 mm) measured.

As shown in FIG. 3, the primer solution was thinly coated on one surface of a polypropylene specimen 1 in a size of 2 mm×25 mm×100 mm and dried at room temperature for 10 minutes. An acryl foam double-sided tape 6 was laminated to the obtained primer coat 2. In order to press-bond the double-sided tape 6, a 5-kg roller was rolled back and force 5 times. After standing for 1 hour, the 180° peel adhesive strength test was performed according to the procedure described in JIS K6845 (1999). The pulling speed was 50 mm/min. The peel strength (N/25 mm) shown in Table 1 was measured.

TABLE 1

| | Maleic Acid- | | Amount of | Molecular | Peel |
|---|---|---|---|---|---|
| Example | Modified | Organic | Diamine | Weight of | Strength |
| No. | Polyolefin | Diamine | Added (%) | Diamine (Mn) | (N/25 mm) |
| Example 1 | MMPO of | polyether | 5 | about 800 | 13 |
| | Preparation | diamine | | | |
| | Example 1 | | | | |
| Example 2 | MMPO of | polyether | 10 | about 800 | 29 |
| | Preparation | diamine | | | |
| | Example 1 | | | | |
| Example 3 | MMPO of | polyether | 20 | about 800 | 48 |
| | Preparation | diamine | | | |
| | Example 1 | | | | |
| Example 4 | MMPO of | polyether | 50 | about 800 | 22 |
| | Preparation | diamine | | | |
| | Example 1 | | | | |
| Example 5 | MMPO of | Jeffamine | 20 | 230 | 10 |
| | Preparation | D230 | | | |
| | Example 1 | | | | |
| Example 6 | MMPO of | Jeffamine | 20 | 400 | 28 |
| | Preparation | D400 | | | |
| | Example 1 | | | | |
| Comparative | No primer coat | | | | 1 |
| Example 1 | | | | | |
| Comparative | MMPO of | — | — | — | 5 |
| Example 2 | Preparation | | | | |
| | Example 1 | | | | |
| Comparative | MMPO of | 2E4MZ | 20 | 110 | 4 |
| Example 3 | Preparation | Imidazole | | | |
| | Example 1 | | | | |
| Comparative | MMPO of | xylylene | 20 | 136 | gelation of |
| Example 4 | Preparation | diamine | | | coating |
| | Example 1 | | | | material |
| Comparative | MMPO of | xylylene | 5 | 136 | gelation of |
| Example 5 | Preparation | diamine | | | coating |
| | Example 1 | | | | material |
| Comparative | MMPO of | hexa- | 20 | 116 | gelation of |
| Example 6 | Preparation | methylene | | | coating |
| | Example 1 | diamine | | | material |
| Comparative | MMPO of | hexa- | 5 | 116 | gelation of |
| Example 7 | Preparation | methylene | | | coating |
| | Example 1 | diamine | | | material |

As seen from the results of Examples 1 to 6 in Table 1, the amount of the organic amine added is suitably from 5 to 50 wt % based on the entire amount of the maleic acid-modified polyolefin and even an organic diamine other than those used in Examples 1 to 4 is effective if the number average molecular weight is 150. Also, it is seen from Comparative Examples 1 and 2 that satisfactory adhesive property cannot be obtained only by using a maleic acid-modified polyolefin alone; from Comparative Example 3 that when a monoamine is added in place of an organic diamine, comparable good adhesive property cannot be obtained; and from Comparative Examples 4 to 7 that when the molecular weight of the organic diamine is less than 150, the primer solution is gelled and does not function as a coating solution.

### Heat Resistance Test

In this test, specimens were produced by using the primer solutions prepared in Comparative Example 1 and Example 2, and heat resistance was evaluated by making changes in the adhesive property test (180° peel adhesive strength test) above.

Similarly to the adhesive property test above, the primer solution was thinly coated on one surface of a polypropylene specimen 1 and dried at room temperature for 10 minutes. An acryl foam double-sided tape 6 was laminated to the obtained primer coat 2. In order to press-bond the double-sided tape 6, a 5-kg roller was rolled back and force 5 times. Subsequently, a part of the double-sided tape 6 was peeled off and as shown in FIG. 3, the double-sided tape 6 was folded back down to 180° while leaving a lamination length of 40 mm. After fixing a 200-g weight 7, the specimen was hung in a temperature-controlled oven (not shown) and the temperature was elevated starting from 38° C. at a rate of 0.4° C./min. The temperature at which the double-sided tape 6 was entirely separated to cause falling of the weight 7 was recorded. As a result, the weight fell at 46° C. in the case of the specimen of Comparative Example 1, whereas falling of the weight was not recognized until a temperature of 76° C. in the case of the specimen of Example 2. This reveals that in Example 2 using the primer composition of the present invention, the heat resistance is greatly enhanced.

1. A primer composition comprising:
(1) a maleic acid-modified polyolefin,
(2) an organic diamine having a number average molecular weight of at least 150, and
(3) a solvent component.

2. The primer composition as defined in claim 1, wherein said organic diamine is selected from the group consisting of an aliphatic diamine, an aromatic diamine, a polyether diamine, a polyamide amine, a modified polyamine and a silicone diamine.

3. The primer composition as defined in claim 1, wherein said organic diamine is contained in an amount of 5 to 50 wt % based on the weight of the maleic acid-modified polyolefin in the primer composition.

4. An adhesive substrate having on the surface thereof a primer coat comprising the primer composition described in claim 1.

5. The adhesive substrate as defined in claim 4, wherein said substrate comprises a polyolefin.
